(19) United States
(12) Patent Application Publication
(10) Pub. No.: US 2006/0231379 A1
(43) Pub. Date: Oct. 19, 2006

(54) Low energy vacuum distillation system using waste heat from water cooled electrical power plant

(76) Inventors: Daniel Raviv, Boca Raton, FL (US); Michael R. Levine, Pinckney, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/184,754

(22) Filed: Jul. 19, 2005

Related U.S. Application Data
(63) Continuation-in-part of application No. 10/665,457, filed on Sep. 19, 2003.
(63) Continuation-in-part of application No. 11/140,657, filed on May 27, 2005.
(60) Provisional application No. 60/412,230, filed on Sep. 20, 2002.
(60) Provisional application No. 60/498,083, filed on Aug. 26, 2003.
(60) Provisional application No. 60/627,884, filed on Nov. 15, 2004.

(51) Int. Cl. B01D 3/10

(52) U.S. Cl. 202/205; 202/186

(57) ABSTRACT

An electric power generating plant using nuclear or fossil fuel to produce steam in a boiler which powers a turbine to generate electricity is disposed adjacent to a body of sea water or fresh water. Spent steam from the turbine is cooled in a primary heat exchanger with water from the body. The heated water from the heat exchanger is cooled in a near-vacuum chamber at the upper end of a column having its lower end in the body of water. The vapor produced in the evaporator is fed to a near-vacuum space in a second condenser supported below the sea level so as to be cooled by the sea water. The condenser has its lower end disposed in a sump of fresh water which is vented to atmosphere or sealed and pressurized, to provide support for the column. Fresh water produced by the condensation may be used for drinking water or other purposes and is pumped for utilization. In an alternative embodiment, the output of the cooling channel of the primary heat exchanger is fed to a cooling tower which further cools the output before it is fed to the vaporizer chamber.

### REFERENCE TO RELATED APPLICATIONS

This application is a continuation-in-part of U.S. patent application Ser. No. 10/665,457, filed Sep. 19, 2003; which claims priority from U.S. Provisional Patent Application Ser. Nos. 60/412,230, filed Sep. 20, 2002 and 60/498,083, filed Aug. 26, 2003. This application is also a continuation-in-part of U.S. patent application Ser. No. 11/140,657, filed May 27, 2005. This application also claims priority from U.S. Provisional Patent Application Ser. No. 60/627,884, filed Nov. 15, 2004. The entire content of each application is incorporated herein by reference.

### FIELD OF THE INVENTION

This invention relates to a system for using the waste heat of a water-cooled, steam-powered electric generating plant to produce desalinated water and to cool the waste water from the plant, and more particularly to such a system employing vacuums created by water columns to evaporate the heated waste water and an underwater condenser to condense the resulting vapor to produce fresh water.

### BACKGROUND OF THE INVENTION

Electric power generating plants are often located adjacent to bodies of water so that the water may be used as a coolant for the power plant. The heated water outputted from the plant's primary heat exchanger is fed back into the sea, and careful management of the heated waste water must be made to avoid localized hot spots which could harm marine life. Accordingly, not only is the energy in the output of the heat exchanger wasted, but it creates a nuisance requiring costly management.

### SUMMARY OF THE INVENTION

The present invention is directed toward a combined electric generation plant and water distiller which might either be powered by conventional fossil fuel or nuclear power, of a unique configuration, which is highly passive and not only produces fresh water but feeds the remaining bulk of the original hot waste water back to the water body at a temperature which is not highly elevated with respect to that body so as to avoid the nuisance of hot spots.

The invention utilizes near-vacuum space disposed above vertical columns of water, the height of which is a function of the pressure at the bottom of the columns. Given normal atmospheric pressure at the bottom of the column, this column is approximately ten meters in height. In a closed chamber above the column a near-vacuum is produced.

The present invention employs a first near-vacuum chamber, which acts as an evaporator for a portion of the heated waste water which is fed out of the plant. As the heated waste water is fed into this evaporator vacuum space, a portion of it is vaporized and the remainder is naturally cooled and fed onto the top of the water column, resulting in a down flow through the column which has its bottom in the large body of water. Thus, cooled water from the heat exchanger output is fed back into the body of water. The vaporized portion is connected to a near-vacuum space at the top of a submerged condenser column which is partially or fully disposed below the water level so as to be cooled by the body of water. The vapor condenses in the second chamber as it is cooled by the surrounding water and flows by gravity to a fresh water sump at the bottom of the second column. The fresh water from the sump is pumped out of the system for consumption.

The height of the water column of this condenser may be varied by controlling the gas pressure applied to its sump. The underwater condenser may be supported below the floor of the large body of water, e.g., the sea floor.

In a large system there are preferably several complete, independent evaporator and condenser systems so if one fails the others continue to operate. Except for the fresh water pump, the system may be totally passive in the sense that it requires no external energy source to operate.

Since water contains atmospheric gases that expand and are released under lower pressures, an apparatus for releasing most of the excess gases can be added. This apparatus may have an additional condenser and some remotely or locally controlled valves, and will be operated occasionally to ensure near-vacuum pressure at the top of the operating condenser(s).

Other objectives, advantages and applications of the present invention will be made apparent by the following detailed description of a preferred embodiment of the invention.

### BRIEF DESCRIPTION OF THE DRAWINGS

The description makes reference to the accompanying drawings in which:

FIG. 1 is a schematic diagram of a preferred embodiment of the waste hot water distilling system;

FIG. 2 is a schematic diagram of an alternative embodiment of the invention employing a cooling tower in addition to the primary heat exchanger;

FIG. 3 is a schematic diagram of an alternative embodiment of the invention utilizing two condensers, and apparatus for purging the condensers of atmospheric gases which accumulate in its near-vacuum chamber because of atmospheric gases dissolved in the water while the other condenser is operational; and

FIG. 4 is a schematic diagram of an alternative embodiment of the invention utilizing a single condenser and apparatus for restoring the near vacuum after a period of operation in which atmospheric gases dissolved in the condensed water accumulate in the chamber and decrease the vacuum.

### DETAILED DESCRIPTION OF THE INVENTION

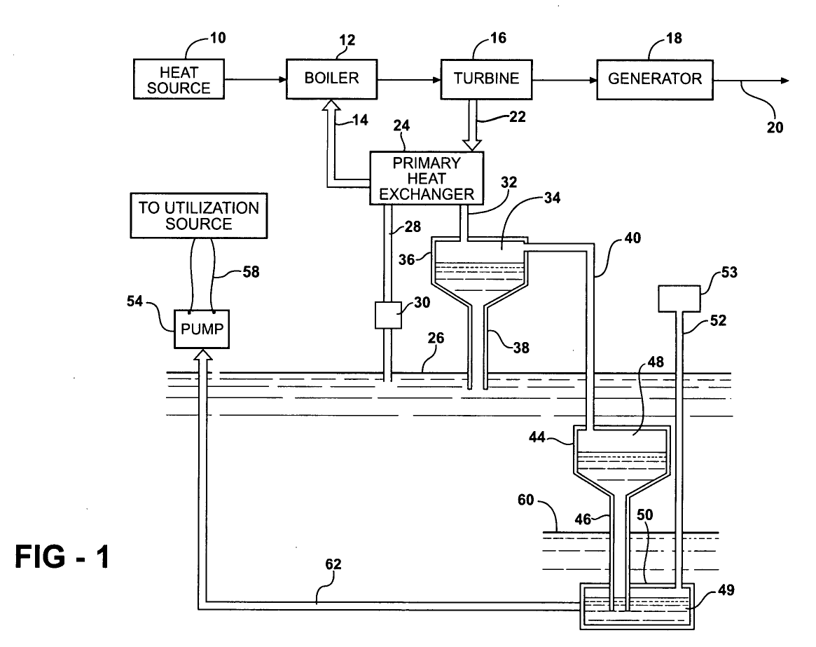

Referring to FIG. 1, a preferred embodiment of the invention employs a heat source 10 to heat a boiler 12. Steam from the boiler drives a turbine 16 to power a generator 18, producing the electrical output from the system on line 20. The spent steam from the turbine 16, on line 22, is fed to a water-cooled heat exchanger 24. The cooled water is fed to the boiler 12 via line 14.

The heated waste water from the heater exchanger 24, on line 32, is typically fed back into the sea 26 and distributed in such a way as to minimize irregular temperature distribution. Pump 30 feeds water into the primary heat exchanger 24.

As thus described the system is conventional. In the system of the present invention the heated water on line 32 from the output of the primary heat exchanger 24 is fed to a near-vacuum space 34 formed in an otherwise sealed chamber 36, rather than being fed to the body of water. A column of water 38 which, along with the water in the chamber 34, has a height of about ten meters relative to the level of the body of water 26, has its lower end disposed within the water 26 so that atmospheric pressure exists on the bottom of the column. This column produces a near-vacuum in the space 34. As the heated water in line 32 from the heat exchanger 24 flows into this near-vacuum space, a portion of it is evaporated. The vapor from the chamber flows through the conduit 40 and the balance of the heated water from the heat exchanger 24, cooled by the vaporization, falls onto the top of the column 38. Water in the column thus flows downwardly due to gravity as the hotter water from the power plant's heat exchanger 24 is added. The water returned to the body of water 26 through the column 38 is substantially cooler than the output of the heat exchanger on line 32 because of the vaporization which occurs in the water near space 34 as well as in space 34. This cooling can be made sufficient to lower the temperature of the returned sea water to a level which is not harmful to marine life.

The vapor from the space 34 is fed through line 40 to a near-vacuum area 48 located at the top of a second sealed chamber 44. The vacuum in this condenser chamber is maintained by a column 46 of fresh water. The chamber 44 is partially or fully disposed within the body of water 26, so that the chamber 44 is cooled by the water to promote condensation of the vapor within the chamber 44. The bottom of the fresh water column 46 is disposed within a sump of fresh water 49 disposed below the chamber 44. Again, the column height, including the water level within the chamber 44, is the maximum height of water that can be sustained by the gas pressure in line 52, fed by an air compressor 53. By varying the pressure of compressor 53, the height of the water in chamber 44 may be adjusted.

A pump 54 draws water from the fresh water sump 49 through a conduit 62 at a rate commensurate with the condensation of water within the chamber 44. The output is fed through line 58 to a utilization device.

The fresh water sump 49 may be sunken beneath the bed 60 of the body of water 26 to physically support the column 46.

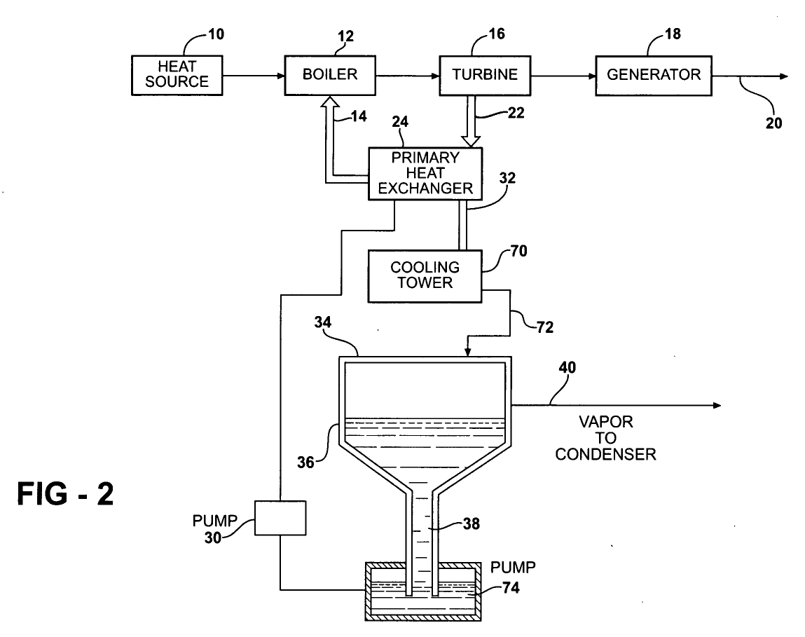

FIG. 2 is an alternative embodiment of our invention employing a cooling tower for cooling the hot water output of the primary heat exchanger. To the extent the system of FIG. 2 employs the same elements as the system of FIG. 1, like numerals are employed to designate the elements.

The system of FIG. 2 feeds the output of the cooling channel of the primary heat exchanger 24 to a cooling tower 70, rather than directly to a vaporizer chamber as does the system of FIG. 1. The cooling tower 70 is of the conventional type which cools the hot water output of primary heat exchanger line 32 with ambient air flow produced by convection currents. The output water from the cooling tower 70, thus reduced in temperature, is fed to the near-vacuum volume, in chamber 36 at the top of column 38. A pump 30 feeds the water accumulating in the sump 74 to the cool channel of the heat exchanger 24. The water in line 72 is cooled in chamber 34 by vaporization and falls onto column 38. This increases the efficiency of the power plant by providing cooled water to the heat exchanger 24, thus lowering the turbine exit temperature.

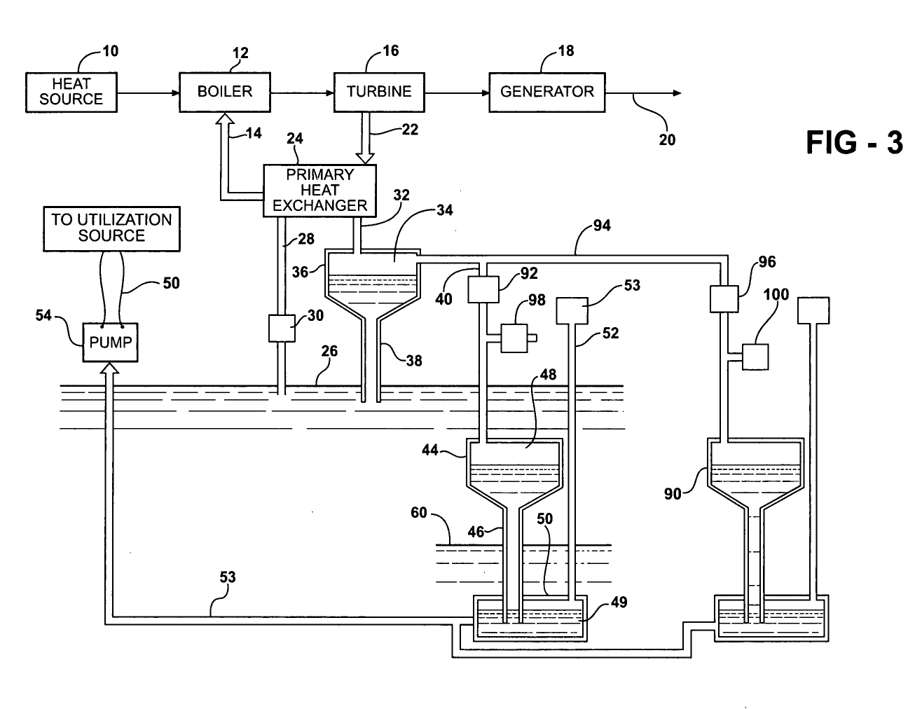

The water vapor fed to the vaporizer chamber 34 in an application of the invention in which new water is continually introduced, and in which the heated water is drawn from an open body of water, will contain a small percentage of dissolved atmospheric gases. As the vapor fed from the vaporizer space 34 to the condenser space 48 through line 40 is condensed, the dissolved atmospheric gases retained in chamber 48 will increase the pressure in space 48 and compromise the near-vacuum pressure necessary for normal operation. After some period of operation, it will be necessary to purge the chamber of this atmospheric gas and refill it with water to renew the near-vacuum condition. The distillation system may be shut down during this time and the output of the heat exchanger 24 may be fed directly into the body of water 26. Alternatively, a system may be provided with two condensers in which one is operative while the other is purged. A system of this type is illustrated in FIG. 3.

The system of FIG. 3 adds a second condenser 90 to the system of FIG. 1. A shutoff valve 92 is added in line 40 connecting the vaporizer 34 to the first condenser 44 and a line 94 feeds vapor to the second condenser 90 through a shutoff valve 96. A purging valve 98 is installed in line 40 between the shutoff valve 92 and the condenser 44, and a similar purge valve 100 is disposed between shutoff valve 96 and the second condenser 90.

The system may begin operation with the first condenser 44 operative and the second condenser on standby. In this mode, the valve 92 will be open and the valve 96 closed.

When atmospheric gas dissolved in the vapor fed to the first condenser accumulates to the point where the near vacuum in condenser 44 is impaired, the valve 92 is closed, disconnecting the condenser 44 from the system and valve 96 is opened, connecting condenser 90. Then the pressure from source 53 is increased, and the valve 98 is opened. This drives water from the sump 49 into the chamber 48, forcing atmospheric gas out of the valve 98. When the water level reaches the valve 98, the valve is closed and the pressure terminated. The condenser 48 is then ready to be connected to the system. Atmospheric gas accumulates in the second condenser 90 to the point where it must be purged using a pressure source 102 and purge valve 100. The two condensers thus alternate in use. More than two condensers could be used in alternative systems.

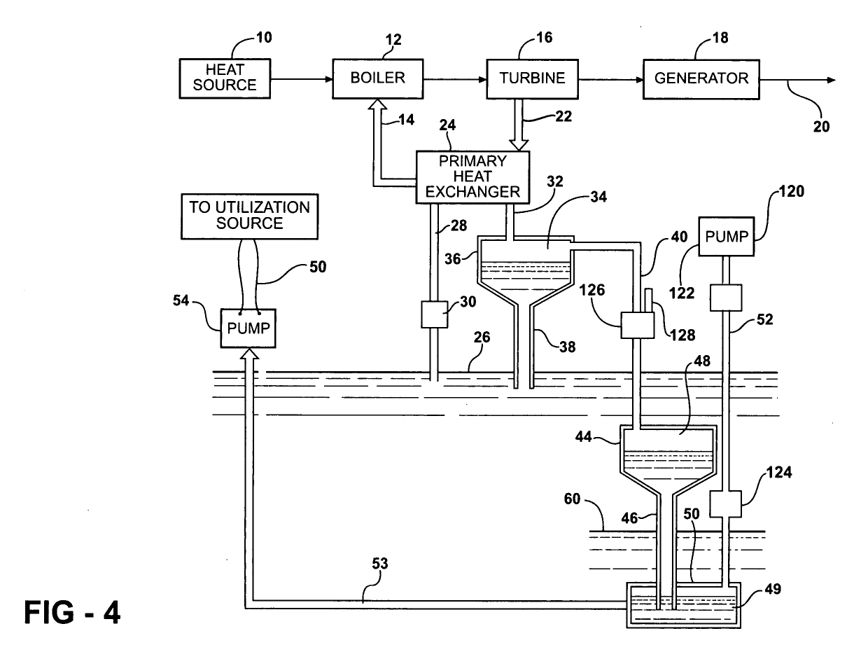

FIG. 4 illustrates an alternative system for purging accumulated atmospheric gases using a single condenser. The system is similar in design to the system of FIG. 1, and like numerals are used for the common elements.

The section of the system fed by the compressor 53 in FIG. 1 to generate pressure at the top of sump 49, and thus adjust the height of column 46, is replaced in FIG. 4 with an air pump 120 which feeds an accumulator 122 to build up a high pressure in the accumulator. A valve 124 connects the accumulator to the bottom of the sump. A three-way valve 162 is placed in the line 40 connecting the top of evaporator 34 with the top 48 of condenser chamber 44. The valve 126 connects the chamber volume 48 with the evaporator 34 during normal operation of the condenser. In its alternate position, used during purging of accumulated atmospheric gases in the volume 48, the valve 126 vents the volume 48 to the atmosphere via pipe 128.

During normal operation of the condenser 44, the pump 120 operates to build high air pressure in the accumulator 122. When atmospheric air accumulates in the chamber volume 48, degrading the vacuum to the point where the condenser is inefficient, the valves 124 and 126 are simultaneously switched. This feeds the high air pressure in the accumulator into the top of the sump 49, forcing water up the column 46. The accumulated gases in the volume 48 at the top of chamber 44 are forced out to the atmosphere through valve 126 feeding pipe 128.

This purge operation takes a very short time, such as a few seconds. The valves 122 and 126 are then switched back to the normal state and the column 46 falls until the near-vacuum condition is reestablished in volume 48 and the condenser, reconnected to the vaporizer 34, resumes operation.

Having thus described our invention, we claim:

1. A system for using heat from hot water to produce distilled water, comprising:
a source of hot water to be distilled;
a column evaporator comprising a sealed chamber connected to a water column of a height sufficient to create a near-vacuum in the sealed chamber;
a conduit for feeding the hot water into the sealed chamber of the column evaporator;
a first condenser, comprising a sealed chamber connected to a water column of a height sufficient to create a near vacuum in a sealed chamber, disposed partially or fully beneath a body of water;
a conduit for feeding vapor from the evaporator chamber to the condenser chamber;
a conduit for allowing flow of distilled water from the condenser; and
a pump to extract distilled water from the condenser.

2. The system of claim 1 wherein the hot water is derived from an electrical power plant.

3. The system of claim 2, wherein the hot water is output water from a primary heat exchanger of the power plant.

4. The system of claim 3, wherein the heat exchanger comprises a cooling tower for the power plant.

5. The system of claim 1 in which the vaporization of water in the evaporator chamber cools water in the evaporator column which is released to a body of water.

6. The system of claim 4, wherein the cooled water in the evaporator column is fed to the cooling tower.

7. The system of claim 3, in which the water from the heat exchanger is fed to a cooling tower.

8. The system of claim 7, in which water from the cooling tower is fed to the evaporator chamber.

9. The system of claim 8, in which cooled water from the evaporator column is fed to the heat exchanger.

10. The system of claim 9, in which the power plant includes a boiler and a turbine and the heat exchanger includes two channels, one connected to receive spent steam from the turbine and feeds its output to the boiler, and the second connected to receive cooled water from the evaporator column and feed its output to the primary heat exchanger.

11. The system of claim 1, further comprising:
a second condenser;
pressure sources connected to the bottoms of the water columns of the first and second condensers; and
valves connecting the first and second condensers and the conduit for feeding vapor from the evaporator chamber to the condenser chamber;
whereby the valves may be operated so that one of the first and second condensers receives vapor from the evaporator chamber while the other condenser may be purged of air by energizing its pressure source.

12. The system of claim 11, wherein the two condensers are alternated between operational and purged conditions in a complementary manner.

13. The system of claim 1, further comprising:
a pump; and
a conduit connecting the output of the pump to the bottom of the water column in the first condenser.

14. The system of claim 13, further comprising valving to dump gases accumulated at the top of the water column in the first condenser to the atmosphere while the output of the pump is applied to the bottom of said water column to force accumulated gases to the atmosphere.

15. The system of claim 14, further comprising an accumulator operative to receive the output of the pump and feed the conduit connecting to the bottom of the water column in the first condenser.
